(19) United States
(12) Patent Application Publication
(10) Pub. No.: US 2025/0109355 A1
(43) Pub. Date: Apr. 3, 2025

(54) PARTICULATE FABRIC TREATMENT COMPOSITION WITH MALODOR REMOVAL/INHIBITION AGENT

(71) Applicant: Henkel AG & Co. KGaA, Duesseldorf (DE)

(72) Inventors: Daniel Thomas Piorkowski, Fairfield, CT (US); Janet Coope-Epstein, Trumbull, CT (US)

(21) Appl. No.: 18/886,388

(22) Filed: Sep. 16, 2024

Related U.S. Application Data
(60) Provisional application No. 63/586,792, filed on Sep. 29, 2023.

(51) Int. Cl. C11D 3/00; C11D 3/04; C11D 3/12; C11D 3/22; C11D 3/50; C11D 17/04; C11D 17/06

(52) U.S. Cl. CPC C11D 3/0068; C11D 3/046; C11D 3/124; C11D 3/222; C11D 3/505; C11D 17/044; C11D 17/06; C11D 2111/12

(57) ABSTRACT

A particulate fabric treatment composition (unitized or non-unitized format) that contains a malodor control agent is provided. The malodor control agent is a highly-branched cyclic dextrin. The particulate fabric treatment composition (unitized or non-unitized format) can be used during the washing of fabrics to eliminate malodor from the washed fabrics.

### CROSS REFERENCE TO RELATED APPLICATION

The present invention claims the benefit of U.S. Provisional Patent Application No. 63/586,792 filed Sep. 29, 2023, the entire content and disclosure of which is incorporated herein by reference.

### BACKGROUND

The present disclosure generally relates to fabric laundering, and more particularly to a particulate fabric treatment composition (unitized or non-unitized format) that contains a malodor control agent and a method of using the same.

Fabrics (or textiles) can become hard due to repeated washings. Also, even after washing, fabrics can have an undesirable smell. To restore their softness, improve their scent, or impart other desirable properties, fabrics are often treated by additional processes that are separate from their washing. The treatments are separate because the fabric-treating compositions are often not compatible with the washing detergent. These additional processes can be done, for example, in the washer during an added cycle, or in the dryer when using a solid composition, such as a dryer sheet. For example, it is well known to provide liquid fabric conditioning compositions that soften washed fabrics. Such compositions are typically added to the fabrics in the rinse cycle of the wash process.

Body odor is one of the most prevalent malodors that consumers seek to address by laundering with various detergents, and also by using fabric conditioning compositions. The chemical constituents within body odor, predominantly short-chained fatty acids and mercaptans, persist on fabrics post-wear and may sometimes continue to be perceivable after washing with conventional laundry products. It would therefore be desirable to identify new approaches to further neutralize these malodors to provide enhanced benefits.

### SUMMARY

A particulate fabric treatment composition (unitized or non-unitized format) that contains a malodor control agent is provided. The malodor control agent is a highly-branched cyclic dextrin. The particulate fabric treatment composition (unitized or non-unitized format) can be used during the washing of fabrics to eliminate malodor from the washed fabrics.

In one aspect of the present disclosure, a particulate fabric treatment composition is provided. In one embodiment, the particulate fabric treatment composition comprises a blend of (a) a solid particulate carrier, and (b) from about 0.05 weight percent to about 10.0 weight of a highly-branched cyclic dextrin, wherein the weight percent of (b) is based on a total weight of the composition.

In another aspect of the present disclosure, a unit dose fabric treatment product is provided. In one embodiment, the unit dose fabric treatment product comprises a pre-determined dose of a particulate fabric treatment composition encapsulated in a container, wherein the particulate fabric treatment composition comprises a blend of (a) a solid particulate carrier, and (b) from about 0.05 weight percent to about 10.0 weight of a highly-branched cyclic dextrin, wherein the weight percent of (b) is based on a total weight of the composition, and wherein the container comprises a water-soluble polymer or water-dispersible polymer.

In either the particulate fabric treatment composition or the unit dose fabric treatment product embodiments, the blend comprises, consists essentially of, or consists of the solid particulate carrier, and the highly-branched cyclic dextrin.

In either the particulate fabric treatment composition or unit dose fabric treatment product embodiments, the highly-branched cyclic dextrin has an average molecular weight of about 100 kilo Daltons to about 5000 kilo Daltons.

In either the particulate fabric treatment composition or the unit dose fabric treatment product embodiments, the highly-branched cyclic dextrin has an average molecular weight of about 500 kilo Daltons to about 3000 kilo Daltons.

In either the particulate fabric treatment composition or the unit dose fabric treatment product embodiments, the highly-branched cyclic dextrin is present in an amount from about 0.1 weight percent to about 5.0 weight percent.

In either the particulate fabric treatment composition or the unit dose fabric treatment product embodiments, the solid particulate carrier is present in an amount from about 50 percent by weight to about 99.5 percent by weight.

In either the particulate fabric treatment composition or the unit dose fabric treatment product embodiments, the solid particulate carrier is sodium chloride.

In either the particulate fabric treatment composition or the unit dose fabric treatment product embodiments, the blend further comprises from about 0.1 percent by weight to about 25.0 percent by weight of a fragrance booster.

In either the particulate fabric treatment composition or the unit dose fabric treatment product embodiments, the fragrance booster comprises at least one fragrance and a fragrance carrier, wherein the at least one fragrance is an ester, an ether, an aldehyde, a ketone, an alcohol, a hydrocarbon, an essential oil, or a combination thereof.

In either the particulate fabric treatment composition or the unit dose fabric treatment product embodiments, the blend further comprises from about 0.1 percent by weight to about 10 percent by weight of a structuring agent.

In either the particulate fabric treatment composition or the unit dose fabric treatment product embodiments, the structuring agent comprises hydrated silica.

### BRIEF DESCRIPTION OF THE DRAWINGS

FIG. 1 (i.e., the sole drawing figure) is process illustration for the preparation of highly-branched cyclic dextrin from amylose.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

### Particulate Fabric Treatment Composition

The present disclosure provides a particulate fabric treatment composition that includes a blend comprising, consisting essentially of, or consisting of, a solid particulate carrier, and a high-branched cyclic dextrin. In embodiments, the particulate fabric treatment composition can also include a fragrance booster and/or a structuring agent. In some embodiments, the blend can be a homogeneous blend. The term “homogeneous” is used in the present disclosure to indicate that the blend is of uniform composition in which all components are in the same phase. In the present application, the components that provide the blend are all solid particles. The particulate fabric treatment composition is a blend of particles that can be used, for example, to treat a textile. The particulate fabric treatment composition can be in unitized format (i.e., encapsulated in a container) or used as loose particles.

The particulate fabric treatment composition can be used, for example, in the washing cycle of a laundry or fabric cleaning method to provide malodor reduction/elimination to the laundry and/or fabric at any time during the fabric cleaning method, including at the beginning of the fabric cleaning method. The particulate fabric treatment composition can further provide additional beneficial agents, including, but not limited to a fragrance, to the washed fabrics. A method for treating textiles or fabrics, during which a particulate fabric treatment composition of the present disclosure is added into a washer containing the textiles or fabrics, is a further subject of this application.

In one aspect, the particulate fabric treatment composition is composed of particles having a particle size between about 0.5 mm and about 10 mm, or between about 0.8 mm to about 7 mm, or about 1 mm to about 3 mm in any spatial direction.

In one aspect, the particulate fabric treatment composition can have a particle weight of between about 2 mg and about 150 mg, or between about 4 mg and about 60 mg, or between about 5 mg and about 10 mg.

The particulate fabric treatment composition is desirably solid at room temperature, for example, at about 25° C., and soluble in the usual working temperature ranges of a wash and/or rinse cycle, and can deliver malodor reduction/elimination to fabrics during a wash cycle.

In one aspect, the particulate fabric treatment composition is solid at temperatures from about 20° C. to about 40° C. In one aspect, the particulate fabric treatment composition is solid at temperatures of about 200 C, 25° C., 30° C., 35° C., or 40° C.

In one aspect, a method of making a particulate fabric treatment composition is provided. In one embodiment, the method includes providing a blend of a solid particulate carrier, a high-branched cyclic dextrin and optionally a fragrance booster and/or a structing agent. In some embodiments, the method includes determining a pre-determined dose of the particulate fabric treatment composition and thereafter encapsulating the pre-determined dose in a water-soluble or water-dispersible container. In some embodiments, a homogeneous blend can be provided. In such embodiments, the ingredients that provide the blend are blended until a homogeneous state is obtained.

The solid particles that provide the particulate fabric treatment composition can be substantially spherical, hemispherical, lentil shaped, oblong shaped, figure-like, flake-shaped, cuboid, cylindrical, cone-shaped, spherical-cap-shaped or lens-shaped, hemispherical, disk-shaped or needle-shaped particles.

In one aspect, the particulate fabric treatment composition of the present disclosure can be used to deliver malodor reduction/elimination to textiles or fabrics. For example, the particulate fabric treatment composition of the present disclosure can be combined with a conventional washing or cleaning composition and brought into contact with the textiles or fabrics, together with a laundry detergent, during the washing cycle of a conventional washing and cleaning process or during hand-washing to deliver malodor reduction/elimination and, in some embodiments, fragrance to the washed textiles.

In one aspect, the particulate fabric treatment composition of the present disclosure can comprise a blend of some or all of the ingredients listed below.

### Highly-Branched Cyclic Dextrin

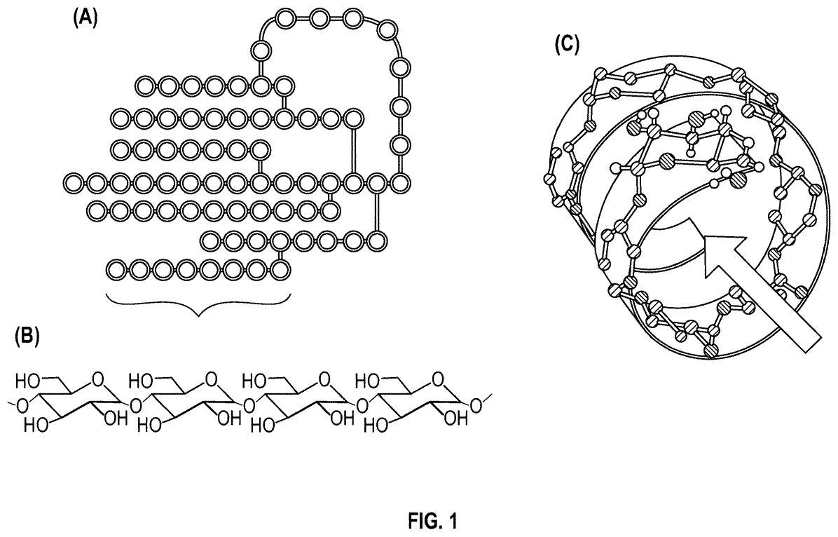

Referring to FIG. 1, dextrin is a polymer of glucose and is produced by a method of enzymatically decomposing a starch, such as amylopectin (for example corn starch). Depending on the enzyme treatment conditions in the manufacturing process, for example, the type and amount of the enzyme, the degree and form of decomposition may be manipulated to produce certain forms, such as branching and molecular weight, of dextrin. Highly-branched cyclic dextrin is one form of dextrin that may be produced in this manner (see portion “A” of FIG. 1), using a cyclization reaction of a branching enzyme (BE,1,4-α-D-glucan: 1,4-α-D-glucan 6-α-D-(1,4-α-D-glucaino-tirarsferase, EC 2.4.1.18). Cyclic dextrin is dextrin characterized in that 6 to 16 glucoses are linked by α-1,4 bonds (see portion “B” of FIG. 1). One example of a cyclic dextrin is α-cyclodextrin, which contains six glucoses. In another example, 3-cyclodextrin contains seven glucoses, and in another example, γ-cyclodextrin contains eight glucoses. Without being bound by any theory, the cyclic dextrin can be in the shape of a coil or a helical structure (see portion “C” of FIG. 1). Commercially available highly-branched cyclic dextrin is in the form of a white powder, is soluble in water, and has a loss on drying of less than about 5.5%. In embodiments of the present application, the highly-branched cyclic dextrin is maltodextrin.

The bonds between the glucoses allow cyclic dextrin to have the coil-like structure or helical-like shown in FIG. 1, containing a certain volume of void space. The array of each interior space is formed by oxygen atoms that form glycoside bridges with hydrogen atoms, Therefore, the inner surface becomes very hydrophobic, and the specific shape and physico-chemical properties of the voids have structural features capable of absorbing organic molecules or portions of organic molecules that match the shape of the inner space of the cyclic dextrin. The outside of the cyclic dextrin, however, remains hydrophilic. In this manner, malodors may be entrained within the voids, and effectively removed from the fabric during a washing cycle. Additionally, in the same manner, malodors may be inhibited in fabrics post-wear. In the present disclosure, the highly-branched cyclic dextrin that is used as a fabric malodor removal/inhibition agent can be referred to as cluster dextrin.

The highly-branched cyclic dextrin compounds (i.e., cluster dextrin) employed as a fabric malodor removal/inhibition agent in the particulate fabric composition (unitized or non-unitized format) of the present disclosure can have an average molecular weight, in embodiments, from about 100 kilo Daltons to about 5000 kilo Daltons, for example from about 500 kilo Daltons to about 3000 kilo Daltons.

In the present disclosure, the highly-branched cyclic dextrin can be included within the particulate fabric treatment composition of the present disclosure in an amount of from about 0.05 weight percent to about 10.0 weight percent, for example, from about 0.1 weight percent to about 8 weight percent, or from about 0.1 weight percent to about 5.0 weight percent. All weight percentages used herein are by total weight of the particulate fabric treatment composition, unless otherwise specifically noted.

### Solid Particulate Carrier

In the present disclosure, the carrier that can be employed is a solid particulate carrier such as, for example, a salt base, a sugar base or mixtures thereof. In embodiments of the present disclosure, the salt base that can be used in the present disclosure as the carrier can comprise an inorganic salt, that is preferably water soluble, Exemplary inorganic salts include, but are not limited to, an alkali metal salt, an alkaline earth metal salt, and combinations thereof, as long as they are water soluble. In some embodiments, the inorganic salt is an alkali metal salt, which can include, for example, salts of lithium, sodium, potassium, or any combination thereof, Useful alkali metal salts can be, for example, alkali metal fluorides, chlorides, bromides, iodides, sulfates, bisulfates, phosphates, monohydrogen phosphates, dihydrogen phosphates, carbonates, monohydrogen carbonates, acetates, citrates, lactates, pyruvates, silicates, ascorbates, or any combination thereof. In some embodiments, the inorganic salt is sodium chloride.

In embodiments of the present disclosure, the sugar base that can be used in the present disclosure at the carrier can comprise a sugar selected from a group consisting of glucose, fructose, galactose, sucrose, maltose, lactose, saccharose and a mixture thereof.

In embodiments of the present application, the carrier can have a particle size ranging from about 10 mesh to about 400 mesh. In some embodiments, the particle size of the carrier can be from about 25 mesh to about 200 mesh or from about 50 mesh to about 150 mesh.

In some embodiments, the salt base or sugar base can be present in an amount from about 50 percent by weight to about 99.5 percent by weight, from about 70 percent by weight to about 99.5 percent by weight, from about 80 percent by weight to about 99 percent by weight, from about 85 percent by weight to about 98.5 percent by weight from about 88 percent by weight to about 95 percent by weight, or from about 90 percent by weight to about 95 percent by weight of the particulate fabric treatment composition.

In some embodiments, the salt base or sugar base further comprises a colorant, a dispersant, free fragrance, enzymes, a bleach, a filler, a dye, and the like. In other embodiments, the salt base or sugar base comprises a salt, a colorant, a fragrance oil, and/or an alcoholic solvent. The alcoholic solvent may be a glycol such as, for example, propylene glycol, dipropylene glycol, or a combination thereof. The organic solvent may be present in the salt or base in an amount from about 0% to about 5.0%, from above 0% to about 2.0%, from above 0% to about 1.0.

### Fragrance Booster

In some embodiments, the particulate fabric treatment composition of the present disclosure can include a fragrance booster. In some embodiments, the fragrance boaster is omitted. In embodiments, the fragrant booster is a solid particulate product including at least one fragrance and a fragrance carrier. The fragrance carrier can include one of the solid particulate carriers mentioned above. The fragrance booster can be made utilizing techniques well known to those skilled in the art.

In one aspect, the fragrance has a melting point that is in the range of from about −100° C. to about 100° C., or from about −80° C. to 80° C., or from about −20° C. to about 50° C., or from about −30° C. to about 20° C. In one aspect, the fragrance can have a melting point that is in the range of from about 25° C. to about 400° C., or from about 50° C. to about 380° C., or from about 75° C. to about 350° C., or from about 100° C. to about 330° C.

In one aspect, the fragrance can be an ester, an ether, an aldehyde, a ketone, an alcohol, a hydrocarbon, an essential oil, and a combination thereof.

In one aspect, the fragrance can be, for example, adoxal (2,6,10-trimethyl-9-undecenal), anisaldehyde (4-methoxybenzaldehyde), cymal (3-(4-isopropyl-phenyl)-2-methylpropanal), ethylvanillin, florhydral (3-(3-isopropylphenyl)butanal), helional (3-(3,4-methylenedioxyphenyl)-2-methylpropanal), heliotropin, hydroxycitronellal, lauraldehyde, lyral (3- and 4-(4-hydroxy-4-methylpentyl)-3-cyclohexene-1-carboxaldehyde), methyl nonyl acetaldehyde, lilial (3-(4-tert-butylphenyl)-2-methylpropanal), phenyl acetaldehyde, undecylenaldehyde, vanillin, 2,6,10-trimethyl-9-undecenal, 3-dodecen-1-al, α-n-amylcinnamaldehyde, melonal (2,6-dimethyl-5-heptenal), 2,4-dimethyl-3-cyclohexene-1-carboxaldehyde (triplal), 4-methoxybenzaldehyde, benzaldehyde, 3-(4-tert-butylphenyl)propanal, 2-methyl-3-(para-methoxyphenyl)propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]decylidene-8)butanal, octahydro-4,7-methano-1H-indenecarboxaldehyde, 3-ethoxy-4-hydroxybenzaldehyde, para-ethyl-α,α-dimethylhydrocinnamaldehyde, α-methyl-3,4-(methylenedioxy)hydrocinnamaldehyde, 3,4-methylenedioxybenzaldehyde, α-n-hexylcinnamaldehyde, m-cymene-7-carboxaldehyde, α-methyl phenylacetaldehyde, 7-hydroxy-3,7-dimethyloctanal, undecanal, 2,4,6-trimethyl-3-cyclohexene-1-carboxaldehyde, 4-(3)(4-methyl-3-pentenyl)-3-cyclohexenecarboxaldehyde, 1-dodecanal, 2,4-dimethylcyclohexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanoindane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyloctanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanoindane-1-carboxaldehyde, 2-methyloctanal, α-methyl-4-(1-methylethyl)benzene acetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methyl nonyl acetaldehyde, hexanal and trans-2-hexenal.

In one aspect, the fragrance can be, for example, methyl β-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), α-damascone, β-damascone, Δ-damascone, iso-damascone, damascenone, methyl dihydrojasmonate, menthone, carvone, camphor, koavone (3,4,5,6,6-pentamethylhept-3en-2-one), fenchone, α-ionone, β-ionone, γ-methyl ionone, fleuramone (2-heptylcyclopentanone), dihydrojasmone, cis-jasmone, Iso E Super (1-(1,2,3,4,5,6J,8-octahydro-2,3,8,8-tetramethyl-2-naphthalenyl)ethan-1-one (and isomers)), methyl cedrenyl ketone, acetophenone, methyl acetophenone, para-methoxyacetophenone, methyl β-naphtyl ketone, benzyl acetone, benzophenone, para-hydroxyphenylbutanone, celery ketone (3-methyl-5-propyl-2-cyclohexenone), 6-isopropyldecahydro-2-naphtone, dimethyl octenone, frescomenthe (2-butan-2-ylcyclohexan-1-one), 4-(1-ethoxyvinyl)-3,3,5,5-tetramethylcyclohexanone, methyl heptenone, 2-(2-(4-methyl-3-cyclohexen-1-yl)propyl)cyclopentanone, 1-(p-menthen-6(2)yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)indanone, 4-damascol, dulcinyl(4-(1,3-benzodioxol-5-yl)butan-2-one), Hexalon (1-(2,6,6-trimethyl-2-cyclohexen-1-yl)-1,6-heptadien-3-one), isocyclemone E (2-acetonaphthone-1,2,3,4,5,6,7,8-octahydro-2,3,8,8-tetramethyl), methyl nonyl ketone, methyl cyclocitrone, methyl lavender ketone, orivone (4-tert-amylcyclohexanone), 4-tert-butylcyclohexanone, delphone (2-pentyl cyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan-1-one), 2,4,4,7-tetramethyloct-6-en-3-one and tetrameran (6,10-dimethylundecen-2-one).

In one aspect, the fragrance can comprise, for example, 10-undecen-1-ol, 2,6-dimethylheptan-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol,4-tert-butylcyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, 8-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylat, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol.

In one aspect, the fragrance can be, for example, benzyl acetate, phenoxyethyl isobutyrate, p-tert-butylcyclohexyl acetate, linalyl acetate, dimethyl benzyl carbinyl acetate (DMBCA), phenyl ethyl acetate, benzyl acetate, ethylmethylphenyl glycinate, allyl cyclohexyl propionate, styralyl propionate, benzyl salicylate, cyclohexyl salicylate, floramat, melusat and jasmacyclat.

In one aspect, the fragrance can be, for example, benzyl ethyl ether and ambroxan. The hydrocarbons include mainly terpenes, such as limonene and pinene.

In one aspect, the fragrance can be a mixture of various fragrances, which can be referred to as a perfume or perfume oil. Perfume oils of this kind can also contain natural fragrance mixtures, as are obtainable from plant sources.

In one aspect, the fragrance can be, for example, essential oils such as angelica root oil, anise oil, arnica blossom oil, basil oil, bay oil, champaca blossom oil, citrus oil, silver fir oil, silver fir cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, canaga oil, cardamom oil, cassia oil, pine needle oil, copaiba balsam oil, coriander oil, spearmint oil, caraway oil, cumin oil, labdanum oil, lavender oil, lemongrass oil, lime blossom oil, lime oil, mandarin oil, balm oil, mint oil, musk seed oil, muscatel oil, myrrh oil, clove oil, neroli oil, niaouli oil, olibanum oil, orange blossom oil, orange oil, origanum oil, palmarosa oil, patchouli oil, peru balsam oil, petitgrain oil, pepper oil, peppermint oil, pimento oil, pine oil, rose oil, rosemary oil, sage oil, sandalwood oil, celery oil, spike oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil and ambrettolide, ambroxan, α-amylcinnamaldehyde, anethol, anisaldehyde, anise alcohol, anisol, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptine carboxylic acid methyl ester, heptaldehyde, hydroquinone dimethyl ether, hydroxycinnamaldehyde, hydroxycinnamyl alcohol, indol, irone, isoeugenol, isoeugenol methyl ether, isosafrole, jasmone, camphor, carvacrol, carvone, p-cresol methyl ether, cumarin, p-methoxyacetophenone, methyl n-amyl ketone, methyl anthranilic acid methyl ester, p-methyl acetophenone, methyl chavicol, p-methyl quinoline, methyl β-naphthyl ketone, methyl n-nonyl acetaldehyde, methyl n-nonyl ketone, muscone, β-naphthol ethyl ether, β-naphthol methyl ether, nerol, n-nonyl aldehyde, nonyl alcohol, n-octyl aldehyde, p-oxy-acetophenone, pentadecanolide, β-phenyl ethyl alcohol, phenyl acetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, γ-undelactone, vanillin, veratrum aldehyde, cinnmaldehyde, cinnamyl alcohol, cinnamic acid, cinnamic acid ethyl ester, cinnamic acid benzyl ester, diphenyl oxide, limonene, linalool, linalyl acetate and propionate, melusat, menthol, menthone, methyl n-heptenone, pinene, phenyl acetaldehyde, terpinyl acetate, citral, citronellal, and mixtures thereof.

In one aspect, the fragrance can have, for example, a musky scent, a pungent scent, a camphoraceous scent, an ethereal scent, a floral scent, a peppermint scent, or any combination thereof.

In one aspect, the fragrance can comprise methyl formate, methyl acetate, methyl butyrate, ethyl butyrate, isoamyl acetate, pentyl butyrate, pentyl pentanoate, octyl acetate, myrcene, geraniol, nerol, citral, citronellol, linalool, nerolidol, limonene, camphor, terpineol, α-ionone, thujone, benzaldehyde, eugenol, cinnamaldehyde, ethyl maltol, vanillin, anisole, anethole, estragole, thymol, indole, pyridine, furaneol, 1-hexanol, cis-3-hexenal, furfural, hexyl cinnamaldehyde, fructone, hexyl acetate, ethyl methyl phenyl glycidate, dihydrojasmone, oct-1-en-3-one, 2-acetyl-1-pyrroline, 6-acetyl-2,3,4,5-tetrahydropyridine, γ-decalactone, γ-nonalactone, Δ-octalone, jasmine lactone, massoia lactone, wine lactone, sotolon, grapefruit mercaptan, methanthiol, methyl phosphine, dimethyl phosphine, nerolin, 2,4,6-trichloroanisole, or any combination thereof.

In one aspect, the fragrance can comprise a linear terpene, a cyclic terpene, an aromatic compound, a lactone, a thiol, or any combination thereof.

Other art-known fragrances, or any fragrance commercially available from a fragrance supplier (for example, Firmenich, Givaudan, International Flavors and Fragrances (IFF), Symriseetc), or combinations of such fragrances, may also suitably be used in the CFTs, compositions, and methods disclosed herein.

In one aspect, the fragrance can be a fragrance precursor. “Fragrance precursor” refers to compounds which only release the actual fragrance following chemical conversion/separation, for example, when exposed to light or other environmental conditions, such as pH, temperature, etc. Compositions of this kind are often referred to as pro-fragrances.

In one aspect, the fragrance can be encapsulated, for example, in a microcapsule or a nanocapsule. The microcapsules and nanocapsules can be water-soluble or water-insoluble. In one aspect, all of the fragrance is encapsulated. Examples of encapsulated fragrances are described in, for example, U.S. Pat. Nos. 6,024,943, 6,056,949, 6,194,375, 6,458,754 and 8,426,353, and US 2011/0224127 A1, each of which is incorporated by reference in its entirety. In one aspect, the fragrance can be a free fragrance, a fragrance precursor, or an encapsulated fragrance, or any combination thereof.

In one aspect, the fragrance boaster is present in the particulate fabric treatment composition in an amount from about 0.1 percent by weight to about 25.0 percent by weight, or from about 0.1 percent by weight to about 20 percent by weight, or from about 0.5 percent by weight to about 20 percent by weight, or from about 0.5 percent by weight to about 15 percent by weight, or from about 1 percent by weight to about 15 percent by weight, or from about 1 percent by weight to about 12 percent by weight, or from about 1.0 percent by weight to about 5% by weight, or from about 3 percent by weight to about 12 percent by weight, based on the total weight of the particulate fabric treatment composition.

### Structuring Agent

In some embodiments, the particulate fabric treatment composition of the present disclosure comprises a structuring agent. In other embodiments, the particulate fabric treatment composition of the present disclosure does not include a structuring agent. The structuring agent is a solid material that can convert any liquid substance or solution into a powder. In one example, the structuring agent is a hydrated silica.

In one aspect, the structuring agent is present in the particulate fabric treatment composition in an amount from about 0.1 percent by weight to about 10 percent by weight, or from about 0.2 percent by weight to 8.0 percent by weight, or from about 0.5 percent by weight to about 3.0 percent by weight, based on the total weight of the particulate fabricate treatment composition.

### Colorant(s)

In one aspect, the particulate fabric treatment composition of the present disclosure further comprises at least one colorant.

In one aspect, the particulate fabric treatment composition does not contain a colorant.

In one aspect, the particulate fabric treatment composition contains one or more colorants. In one aspect, the colorant can be a water-soluble polymer, water-insoluble polymer, a water-soluble dye, a water-insoluble dye, or a combination thereof.

In one aspect, the colorant(s) can be, for example, red, orange, yellow, blue, indigo, violet, or any combination thereof.

In one aspect, the colorant(s) can be Violet LS, Royal MC, Blue HP, Blue MC, Aquamarine, Green HMC, Bright Yellow, Yellow LP, Yellow BL, Brilliant Orange, Crimson, Red MX, Pink AL, Red BL, Red ST, Acid Blue 80, Acid Red 52, Acid Violet 48, Liquitint blue HP, Liquitint Bright Yellow Liquid, or a combination thereof.

In one aspect, the colorant(s) can be present in an amount of from about 0.0001% by weight to about 2.0% by weight, or from about 0.0001% by weight to about 1.5% by weight, or from about 0.0001% by weight to about 1.0% by weight, or from about 0.0001% by weight to about 0.5% by weight, or from about 0.001% by weight to about 0.3% by weight, or from about 0.001% by weight to about 0.1% by weight, or from about 0.001% by weight to about 0.05% by weight, or from about 0.001% by weight to about 0.025% by weight, or about 0.001% by weight, or about 0.002% by weight, or about 0.003% by weight, or about 0.0035% by weight of the composition.

### Unitized Format

In some embodiments, the particulate fabric treatment composition of the present disclosure can be in unitized format (i.e., encapsulated in a container that is made from a water-soluble polymer or water-dispersible polymer). The unitized format can be referred to herein as a unit dose fabric treatment product. In other embodiments, the particulate fabric treatment composition of the present disclosure is not encapsulated in a container and is used as is, i.e., in particulate form without any water-soluble or water-dispersible container.

The container that can be used includes a water-soluble or water-dispersible polymer film, which encloses a pre-determined dose of the particulate fabric treatment composition of the present disclosure. The container can be in any desirable shape and size, e.g., square, rectangular, oval, elliptoid, super-elliptical, or circular shape. The unit dose container can contain more than one chamber. In such embodiments, at least one of the chambers of the unit dose containing contains the unit dose fabric treatment product of the present disclosure.

The pre-determined dose of the particulate fabric treatment composition is an amount of the particulate fabric treatment composition which can be used in laundering of fabrics to provide malodor reduction/elimination, and to impart scent (i.e., apply fragrance to) to a fabric or textile. In one example, pre-determined dose is from about 0.001 g to about 1 kg per treatment.

Non-limiting examples of water-soluble or water-dispersible polymers include polyvinyl alcohol, eel ulose ethers, polyethylene oxide, starch, poly vinylpyrrolidone, polyacrylamide, polyacrylonitrile, polyvinyl methyl ether-maleic anhydride, polymaleic anhydride, styrene maleic anhydride, hydroxyethylcellulose, methylcellulose, polyethylene glycol, carboxymethylcellulose, polyacrylic acid salts, alginates, acrylamide copolymers, guar gun, casein, ethylene-maleic anhydride resins, polyethyleneimine, ethyl hydroxyethylcellulose, ethyl methylcellulose, hydroxyethyl methylcellulose, film forming cellulosic polymer, polyanhydride, polysaccharide, polyalkylene oxide, cellulose, cellulose ester, cellulose amide, polyvinyl acetate, polycarboxylic acid and salt, polyaminoacid, polyamide, natural gums, polyacrylate, water-soluble acrylate copolymer, methylcellulose, carboxymethylcellulose sodium, dextrin, ethylcellulose, maltodextrin, polymethacrylate, polyvinyl alcohol copolymer, aid combinations thereof.

In some embodiments, the water-soluble or water-dispersible polymer may be polyvinyl alcohol, polyvinyl acetate, film forming cellulosic polymer, polyacrylic acid, polyacrylamide, polyanhydride, polysaccharide, or a mixture thereof. In one example, the water-soluble or water-dispersible film material is polyvinyl alcohol or polyvinyl acetate. In another example, the water-soluble or water-dispersible polymer is made from a lower molecular weight water-soluble polyvinyl alcohol film-forming resin.

In some embodiments, the water-soluble or water-dispersible container can further contain a cross-linking agent. In one embodiment, the cross-linking agent can be boric acid or sodium borate.

The film material that provides the container in the unitized embodiment can have a thickness of between about 50 microns to about 120 microns, with a thickness between about 60 microns to about 100 microns being more typical.

The water-soluble or water-dispersible container can be prepared in any suitable way, such as via molding, casting, extruding or blowing, and is then filled using an automated filling process, as known in the prior art.

### Methods of Use

The particulate fabric treatment composition (unitized or non-unitized format) of the present disclosure can be used to treat fabrics or textiles, for example, to provide malodor reduction/elimination, and, in some embodiments, to impart scent (i.e., apply fragrance to) to a fabric or textile.

In one aspect, the present disclosure provides a method of treating a fabric or a textile comprising combining or contacting the fabric or textile to be treated, with water and the particulate fabric treatment composition (unitized or non-unitized format) in accordance with the present disclosure. The particulate fabric treatment composition can be unitized (i.e., in a container as described above) or used as is, i.e., in particulate form. The amount of particulate fabric treatment composition can be, for example, about 0.001 g to about 1 kg per treatment. The amount of the particulate fabric treatment composition can be, for example, about 0.01 g, about 0.1 g, about 1 g, about 2 g, about 3 g, about 4 g, about 5 g, about 6 g, about 7 g, about 8 g, about 9 g, about 10 g, about 25 g, about 50 g, about 100 g, about 200 g, about 300 g, about 400 g, about 500 g, about 600 g, about 700 g, about 800 g, or about 900 g per treatment.

The particulate fabric treatment composition (unitized or non-unitized format) can be used in a top loading or front loading washer, in hot, warm, or cold water. The particulate fabric treatment composition can be used with a detergent in a wash cycle, or separately but in conjunction with a detergent (for example, in a separate wash or rinse cycle).

In one aspect, the disclosure provides a textile treated by a particulate fabric treatment composition (unitized or non-unitized format), as disclosed herein.

In one aspect, the particulate fabric treatment composition can be added to an amount of water or wash liquor in which a textile is washed by hand.

The textile, after being treated, can be further processed, for example by drying, pressing, ironing, steaming, sewing, and the like.

### Formulations

Formulations (abbreviated as formula) are set forth in Table 1 below. Formulations 1 and 2 are not of the present disclosure, while formulations 3 and 4 are of the present disclosure. Formulations 1 and 2 are thus labeled as non-inventive in Table 1, while formulations 3 and 4 are labeled as inventive. The components listed in Table 1 for the various formulations can be added to a standard powder mixing vessel and mixing can occur until a blend is achieved (typically about 10 minutes to 15 about minutes)

TABLE 1

| | Wt % of | Wt % of | | |
|---|---|---|---|---|
| | Formula 1 | Formula 2 | Wt % of | Wt % of |
| | (Non- | (Non- | Formula 3 | Formula 4 |
| Component | Inventive) | Inventive) | (Inventive) | (Inventive) |
| Sodium | 96.83 | 96.83 | q/s to 100 | q/s to 100 |
| Chloride | | | | |
| Crystals | | | | |
| Propanediol-1,2 | N/A | 0.14 | N/A | N/A |
| Liquitint | N/A | 0.01 | N/A | N/A |
| Aquamarine | | | | |
| Liquitint bright | N/A | 0.04 | N/A | N/A |
| Yellow | | | | |
| Fragrance | N/A | 1.44 | N/A | N/A |
| Fragrance Booster | 1.63 | N/A | 1.63 | N/A |
| Hydrated Silica | 0.54 | 0.54 | 0.54 | 0.54 |
| Highly-Branched | N/A | N/A | 0.1 to 5.0 | 0.1 to 5.0 |
| Cyclic Dextrin | | | | |

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A particulate fabric treatment composition comprising:
a blend of (a) a solid particulate carrier, and (b) from about 0.05 weight percent to about 10.0 weight of a highly-branched cyclic dextrin, wherein the weight percent of (b) is based on a total weight of the composition.

2. The particulate fabric treatment composition of claim 1, wherein the highly-branched cyclic dextrin has an average molecular weight of about 100 kilo Daltons to about 5000 kilo Daltons.

3. The particulate fabric treatment composition of claim 1, wherein the highly-branched cyclic dextrin has an average molecular weight of about 500 kilo Daltons to about 3000 kilo Daltons.

4. The particulate fabric treatment composition of claim 1, wherein the highly-branched cyclic dextrin is present in an amount from about 0.1 weight percent to about 5.0 weight percent based on a total weight of the composition.

5. The particulate fabric treatment composition of claim 1, wherein the solid particulate carrier is present in an amount from about 50 percent by weight to about 99.5 percent by weight based on a total weight of the composition.

6. The particulate fabric treatment composition of claim 5, wherein the solid particulate carrier is sodium chloride.

7. The particulate fabric treatment composition of claim 5, wherein the blend further comprises from about 0.1 percent by weight to about 25.0 percent by weight of a fragrance booster.

8. The particulate fabric treatment composition of claim 7, wherein fragrance booster comprises at least one fragrance and a fragrance carrier, wherein the at least one fragrance is an ester, an ether, an aldehyde, a ketone, an alcohol, a hydrocarbon, an essential oil, or a combination thereof.

9. The particulate fabric treatment composition of claim 5, wherein the blend further comprises from about 0.1 percent by weight to about 10 percent by weight of a structuring agent.

10. The particulate fabric treatment composition of claim 9, wherein the structuring agent comprises hydrated silica.

11. A unit dose fabric treatment product comprising:
a pre-determined dose of a particulate fabric treatment composition encapsulated in a container, wherein the particulate fabric treatment composition comprises a blend of (a) a solid particulate carrier, and (b) from about 0.05 weight percent to about 10.0 weight of a highly-branched cyclic dextrin, wherein the weight percent of (b) is based on a total weight of the composition, and wherein the container comprises a water-soluble polymer or water-dispersible polymer.

12. The unit dose fabric treatment product of claim 11, wherein the highly-branched cyclic dextrin has an average molecular weight of about 100 kilo Daltons to about 5000 kilo Daltons.

13. The unit dose fabric treatment product of claim 11, wherein the highly-branched cyclic dextrin has an average molecular weight of about 500 kilo Daltons to about 3000 kilo Daltons.

14. The unit dose fabric treatment product of claim 11, wherein the highly-branched cyclic dextrin is present in an amount from about 0.1 weight percent to about 5.0 weight percent based on a total weight of the composition.

15. The unit dose fabric treatment product of claim 11, wherein the solid particulate carrier is present in an amount from about 50 percent by weight to about 99.5 percent by weight based on a total weight of the composition.

16. The unit dose fabric treatment product of claim 15, wherein the solid particulate carrier is sodium chloride.

17. The unit dose fabric treatment product of claim 15, wherein the blend further comprises from about 0.1 percent by weight to about 25.0 percent by weight of a fragrance booster.

18. The unit dose fabric treatment product of claim 17, wherein the fragrance booster comprises at least one fragrance and a fragrance carrier, and wherein the at least one fragrance is an ester, an ether, an aldehyde, a ketone, an alcohol, a hydrocarbon, an essential oil, or a combination thereof.

19. The unit dose fabric treatment product of claim 14, wherein the blend further comprises from about 0.1 percent by weight to about 10 percent by weight of a structuring agent.

20. The unit dose fabric treatment product of claim 19, wherein the structuring agent comprises hydrated silica.
